(19) United States
(12) Patent Application Publication
(10) Pub. No.: US 2013/0046574 A1
(43) Pub. Date: Feb. 21, 2013

(54) SYSTEM AND METHOD FOR TRANSMISSION OF GOODS THROUGH A DISTRIBUTION NETWORK

(71) Applicants: Justin Griep, Denver, CO (US); David Bennett, Carlsbad, CA (US)

(72) Inventors: Justin Griep, Denver, CO (US); David Bennett, Carlsbad, CA (US)

(73) Assignee: DEMANDPOINT INC., Englewood, CO (US)

(21) Appl. No.: 13/588,865

(22) Filed: Aug. 17, 2012

Related U.S. Application Data
(60) Provisional application No. 61/524,631, filed on Aug. 17, 2011.

(51) Int. Cl. G06Q 10/06

(52) U.S. Cl. 705/7.25

(57) ABSTRACT

A system and method for replenishing product in an inventory of a distribution network having a plurality of levels, wherein the system and method may include determining an independent quantity demanded of a product at a first-level entity of the distribution network associated with customer demand directly from the first-level entity; determining a dependent quantity demanded of the product at the first-level entity associated with overall demand from the distribution network apportioned to the first-level entity; summing the quantities demanded in the preceding steps to determine a total quantity demanded for the first-level entity; repeating the preceding actions for levels of the distribution network eligible for processing up to a highest-level entity of the distribution network, thereby generating a plurality of quantity-demanded sums for the respective entities; and calculating a total quantity demanded of the product for the distribution network by summing the quantity-demanded sums of the respective entities.

### CROSS-REFERENCE TO RELATED APPLICATIONS

This application claims the benefit of U.S. Provisional Patent Application Ser. No. 61/524,631, filed Aug. 17, 2011, entitled “Rapid Distribution Planning”, [Attorney Docket 1110-00005], the entire disclosure of which application is hereby incorporated by reference herein.

### BACKGROUND OF THE INVENTION

This application is directed in general to distribution systems and in particular to rapid distribution of goods through a supply chain network.

A number of software systems are available for planning the distribution of goods in a supply chain network within an organization. Such systems typically use Advanced Planning and Scheduling (APS) system techniques for attempting to create a plan subject to specified constraints and to optimize results. These techniques are based on complex optimization theory. The inputs are: orders, predicted demand (forecast), current on hand inventories, safety stock, and a distribution network. This process then produces recommended inventory transfer orders and in some cases more optimal inventory levels.

Because of the nature of the typical optimization theory based planning system, various problems exist in the art. It is difficult for planners to understand results and reasons for decisions made by the system, which can lead to planners not trusting computed results and/or not participating as actively as possible in the decision making process.

Constraint models that are needed to operate the system effectively can be complex and time consuming to maintain, thereby increasing the overhead required to operate such systems. Run times for the overall algorithms can be long (many hours), and do not provide the ability to rapidly re-plan or produce multiple “what-if” scenarios, thereby negatively impacting the ability of a business to respond quickly to market changes.

### SUMMARY OF THE INVENTION

According to one aspect, the invention is direct to a system and method for replenishing product in an inventory of a distribution network having a plurality of levels, wherein the system and method may include determining an independent quantity demanded of a product at a first-level entity of the distribution network associated with customer demand directly from the first-level entity; determining a dependent quantity demanded of the product at the first-level entity associated with overall demand from the distribution network apportioned to the first-level entity; summing the quantities demanded in the preceding steps to determine a total quantity demanded for the first-level entity; repeating the preceding actions for levels of the distribution network eligible for processing up to a highest-level entity of the distribution network, thereby generating a plurality of quantity-demanded sums for the respective entities; and calculating a total quantity demanded of the product for the distribution network by summing the quantity-demanded sums of the respective entities.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of an exemplary distribution network on which an embodiment of the present invention may be practiced;

FIG. 2 is a block diagram a retailer, two stores to which the retailer ships product, and respective lead times separating the two stores from the retailer, in accordance with an embodiment of the present invention;

FIG. 3 is a chart showing a activities that may be performed, as a function of time, by the retailer and two retail stores of FIG. 2, in accordance with an embodiment of the present invention;

FIG. 4 is a functional block diagram of a portion of the operational activity of an embodiment of the present invention; and

FIG. 5 is a block diagram of a data processing system useable in conjunction with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

### Solution Overview:

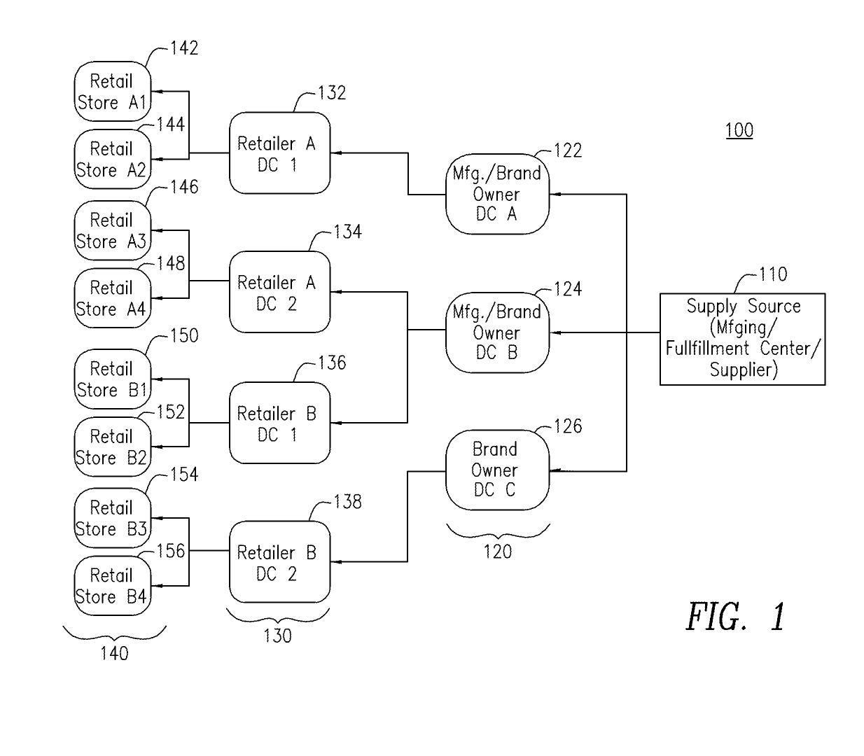

The Demand Flow Platform (DFP) is a planning system that has been designed to address the entire supply chain 100 (FIG. 1). An area of interest within the overall supply chain is distribution, where a plan can be created for the movement of goods from supply through to consumption by end consumers.

The Distribution network 100 may include a network of locations with various possible routes between these locations. An example of this is a network that starts with the manufacturing plants 110 goes to the manufacturer's distribution center (DC) then to the retailer's distribution centers and finally to retail stores 140. An illustration of one such network 100 is shown in FIG. 1. Planners using a distribution planning system want to know when and what goods to ship from one location to another, with a plan that will maintain a high level of customer service, while keeping inventory levels at a minimal level. Additionally, the volume of new goods to be manufactured as of a particular date must also be determine based upon demands of various distribution centers and retain stores.

An embodiment of the present invention aligns each step in the supply chain relative to lead-time to the end consumer and proceeds step by step forward in time applying standard decision making processes to handle constraints.

An embodiment of the system disclosed herein is called Rapid Distribution Planning because the nature of this algorithm is that it runs more quickly than do existing systems. The benefits of this solution may include the following.

Planners can understand how the underlying algorithm operates without as much expert knowledge in mathematics and computer science, thereby allowing them to participate in the planning process and decisions by the system without it being such a black box.

The initial setup and maintenance of the planning system requires a basic set of data to operate, making it as easy as possible for planners to maintain the system.

Because the algorithm runs quickly, planners are more rapidly able to react to real-time changes in the market and quickly compare many different scenarios, either manually or automatically.

The remainder of this document describes the Rapid Distribution Planning system in two parts. First, we describe data that is used as input to the system and the eventual output of the solution to lay the base. In the second part, we review the details of the core algorithm and the associated calculations that execute the planning.

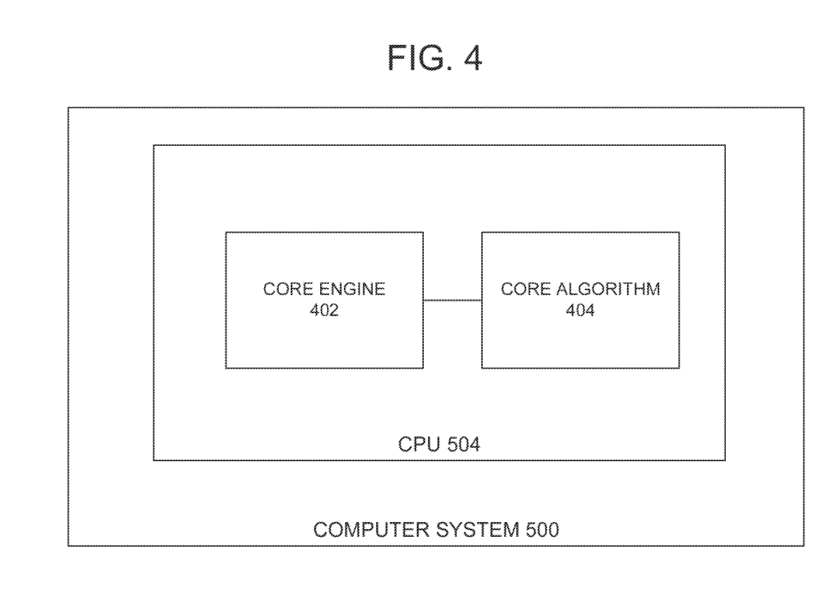

The system that runs the planning algorithm and manages the data will also be referred to as an engine. In the final section, the features that can be added to the core algorithm 404 (FIG. 4) to provide additional benefits are described.

The following is a summary of features of the present invention:

1. An embodiment employs a time offset approach to building a distribution plan with calculating time offsets and running a time step processing that waits based on these offsets (see Processing Offsets, High Level Algorithm Steps, and Calculate Wait Time).
2. An embodiment may include calculating demand for locations recursively, in the upstream direction. (See Aggregate Network Demand).
3. An embodiment may include processing the time buckets by location, recursively in the downstream direction. (See Processing Time Bucket for Location).
4. An embodiment may include various allocation routines (see Supply Allocation).
5. An embodiment may combine one or more of the above with any number of selected advanced features (see Distribution Planning Advanced Features).

### Distribution Planning Data Requirements

Getting into the complexities of the mechanics of the Rapid Distribution Planning is best served by first understanding the data inputs that are required to run the algorithm and the ultimate data outputs produced. This section will discuss the data elements and give some overall context for each. We note that that the data may be product-specific, physical-location specific, and/or specific to a segment or “bucket” of time.

### Data Inputs

The following are a list of the main data elements that may be used by the engine to implement the methods contemplated herein.

### Product Master

This is the list of products that the engine may process. The core engine runs once per specific product. Attributes of a product can be utilized by the engine for decision making

### Location Master

The core engine 402 (FIG. 4) may employ a list of locations to which the products may be directed, in addition to having a list of products. These are preferably physical locations along a chain of distribution. The locations may be used to create distribution networks, which are described in the next section. Locations can also have attributes, such as addresses, geo-coding, an identification which company owns the location, and location type, such as store, retail distribution center, manufacturer/brand owner distribution center, and manufacturing plant. These attributes of a location can also be utilized by the engine for decision making

Distribution Network with Lead Times

A distribution network may be expressed using a graph of nodes and connections representing the flow of products through locations from a product source to an end consumer (that is, from one end of the distribution network to the other end). Different products can have different distribution networks. With each network node representing a location, a connection between two nodes in a network diagram indicates that goods can be shipped between the two locations that correspond to the two respective nodes. An exemplary distribution network is shown in FIG. 1.

The process of shipping benefits from defining a time period starting from the point in time at which a decision to ship a good is made, to the point in time at which the good (i.e. product) is received at a particular location. This shipping period may be referred to herein as a “lead time.”

Reference is made to FIG. 1 in the following with regard to a discussion of how the network may be structured for the Rapid Distribution Planning.

Each line in FIG. 1 represents a lead time. Thus, for example, shipping from Retailer A DC1 132 to Retail Store A1 142 may take 4 days. The lead time and its relationship to the planning solution will be discussed in greater detail later in this document.

While this tree has different types of locations as levels in the hierarchy, with each column occupying a different level in the hierarchy, this is not a requirement of the algorithm and may not reflect an actual distribution network. There are many distribution networks where different types of locations can appear at different levels.

A distribution network also implies an assignment of products to locations, which could also be provided explicitly. Some locations, such as a store for example, may not have inventory of every product offered. In some cases, a particular product may be held in inventory by only one retailer. Each distribution network can be specified by product. The distribution network for the core algorithm preferably meets the following requirements.

In one embodiment, the distribution network is preferably represented strictly as a tree, as parent-child graph. Preferably, the flow is one-directional and products cannot loop back to a prior location in the tree structure. Preferably, no location can occur more than once in the tree.

The root of the tree is preferably the source of supply for the planning (such as a factory). The leaf nodes of the tree are the end consumer location for the planning (such as a store).

The above-listed constraints do not allow for alternate points of supply in the core algorithm. However, the core algorithm 402 can be extended to allow for decision making against multiple points of supply (this will be discussed in the advance features section).

### Allocation Priorities

When the algorithm runs, there may not be enough supply of product available to meet the demand. This may mean that some requests for goods will be accorded higher priority than other requests. This may also be referred to as prioritizing demand from different retailers, or other entity on the tree structure of FIG. 1. This prioritization may be configured in a large number of ways, based on the allocation techniques used.

One approach to prioritizing demand is by prioritizing one location over another and fulfilling the demand at the highest priority demand locations first, and then moving down through lower priority locations until the supply is exhausted. Using this approach, the data input to the core may represent a given location and the priority level accorded to the given location.

### Current On-Hand Inventory Quantities

The current, on-hand inventory quantity is the current amount of a given product held in inventory at a given location. Consideration may be given to whether or not the inventory should include allocated inventory (typically allocated to ship in the future) or not. This may take into account whether or not the engine will be subtracting overlapping orders that both are in the allocation and the data provided to the engine (see Transfer Orders and Open Orders).

### Inventory Targets

An inventory target (also referred to herein as an inventory target amount or merely “target amount”) is the amount of a product that should be available at a given location. The “amount” may be expressed in terms of a number of physical units of the product and/or by a number of days of supply of the product. If the target amount is expressed in terms of a supply of product sufficient for a specified period of time, the core engine may convert that number into a number of units of product based on the currently prevailing rate at which units of the product are demanded at the pertinent point in time.

Inventory target values may be calculated and optimized. For the basic engine, it is assumed that the values described above are prepared beforehand and provided by a user or another module. The core engine could also integrate inventory optimization techniques, which is discussed in the advanced features section.

### Transfer Orders

A transfer order is an order of a quantity of a specific product to be shipped from one location to another, with the product shipping at a specified time and arriving at a later time. Transfer orders in systems have a status. Statuses (also referred to herein as status values) that are beneficial for use by the core algorithm may include “in transit” and “locked” (i.e. committed to ship in the future). However, the present invention is not limited to using the above-listed status values.

Other future transfer orders may be considered “planned,” which means that they may be likely to ship at that time, but there is no firm commitment to ship. Planned orders may be useful if the core engine considers some planned orders to have value in decision making for conflicts. However, the use of planned orders is optional.

### Historical Demand/Shipments

Historical demand may include data listing past orders of given products that were actually sold or shipped to a customer. This could be covered by both point of sale (POS) data for consumers or shipments from a brand owner to a retailer and/or any other type of customer of a product. Historical demand may be useful for some decision making by the core engine and especially for some of the advanced features described later.

### Open Orders

Open Orders are orders that are committed to be fulfilled for a customer of a product. In an embodiment, open orders represent actual future demand that the core engine may employ in calculations to be performed thereby. For example, an order may be shipped to a retailer where 200 units of a product are expected to arrive on a specified date at a retailer's distribution center.

### Forecasted Demand

The distribution planning engine preferably has access to data indicative of what customers will buy in the future to enable prediction of future orders and shipments of one or more products. This is referred to herein as predicted demand, or alternatively as “forecasted demand.”

This forecasted demand may be expressed in terms of a combination of a specific product and a location from which the product will be consumed at a given point in time. The forecasted-demand data may be generated in a number of ways and imported in to the system. However, we also provide a forecast planning module that may include this functionality. The accuracy of the forecast may have a direct effect on the accuracy of the distribution plan produced.

### Supply Plan

The distribution network of FIG. 1 needs to be supplied from some source. Possible sources of product for the distribution network may include a third party that produces a product or a client's own manufacturing plant. There can be an effectively unlimited supply product, in which case the supply plan is not needed as an input, because from the start of the planning and extending into the future, there is no constraint on the supply. Although in practice, this is rarely realistic, as capacity and material constraints impose limitations on the supply of product.

With reference to the above, the supply plan preferably identifies the amount of product needed by various participants in the network and the point in time at which shipments of the respective product amounts are needed. In an embodiments, the supply plan is the all-encompassing plan for the distribution network since this plan directs product downstream through supply chain 100. The supply of product can come from a manufacturing plant or from another retail or inventory center that is directed to serve as the ultimate source for a particular distribution network. In some cases, the supply plan can be unconstrained, but in other more complex scenarios this supply plan can be constrained by attributes of the supplier, such as manufacturing capacity.

In an embodiment, a supply plan is in existence, and some portion of the near-term future shipment activity is subject to constraints, and is thus not changed. The distribution planning engine may be provided with this information so that the quantity of product to be supplied can be accurately determined and made available for allocation among various destinations (such as, for instance, various buyers). Alternatively, there may be some cases in which a planned distribution of product is able to change within certain constraints. This is contemplated in the advanced features and integration with material/capacity planning

### Data Outputs

An objective of one embodiment of the present invention is to provide a plan or algorithm that indicates what product should be transferred from which sources to which destinations, while satisfying demand, and minimizing inventory. Preferably, a preferred system provides details regarding the expected results of the distribution method, and the contributing factors to one or more product shipment decisions at various points in time. The values output by an algorithm according an embodiment herein may include product to be shipped, locations to be shipped from, locations shipped to, the point in time at which shipment occurs, the point in time at which delivery is expected, and possibly, the duration of each shipment step. Systems and methods for actually conducting the shipments of product and/or storage of quantities of product in inventory in accordance with the calculated allocations of product quantities are preferably deployed and used as needed. In this manner, the various data processing hardware and data processing algorithms disclosed herein operate to control the movement of product through a distribution network in addition to calculating quantities of product to shipped, stored, etc.

### Time Buckets

It is helpful to define units of time for calculation to be performed in operating the Rapid Distribution Planning process, since the core engine 402 (FIG. 4) preferably conducts calculations using data that may include discreet units of time for shipping periods or some other prescribed unit of time. These discrete units of time are referred to herein as “time buckets” or alternatively as “time segments.”

Time buckets may have any duration, but will most often be measured in units of days, as most shipping time periods are measured in days. To optimize storage for what can potentially be a very large dataset, the core engine 402 may run programs using a relatively granular measure of time, such as days. However, for the sake of data storage efficiency, time period data may be aggregated into larger units of time, such as weeks, months, or other larger unit of time.

A plurality of system data outputs (such as location inventory quantities, etc.) are discussed below. Timing related data may be determined for one or more of the system data outputs, which may include a duration of the task, a point in time at which the task begins, and/or a point in time at which the task concludes. Otherwise stated, data indicating the “time bucket” in which the task occurs may be determined and suitably stored.

### Location Inventory Quantities

As the core engine 402 processes data, it may calculate values used for specifying operations to be conducted for supply location, each type of product, and for each time segment, which may also be referred to as a time bucket. The above-listed values may be used to track what is happening between sales, to track shipments, and to track the inventory held at each location.

The values that specify operations may vary based on the features that are added to the core of the planning algorithm, but some of the most basic values are: Quantity On Hand; Quantity Sold; Quantity Received (Incoming supply plan or transfer orders); Quantity Shipped (Outgoing transfer orders; Quantity Missed Sales; and Quantity Carry-Over Sales.

### Transfer Orders

Transfer orders were discussed above in the Data Input section. In one embodiment, transfer orders may be the primary data output of the core engine and may be used by the core engine for execution of a distribution plan.

### Supply Plan

The system may also produce a supply plan, identifying: (a) the quantities of each product type needed; (b) the sources from which the respective product types may be obtained; and/or (c) the time bucket (i.e. time segment) in which each specified quantity of product is needed. The above data (a) through (c) may apply even if the supply of product is not constrained. If the supply of product is constrained, a capability for capacity planning may be added.

### Distribution Planning Algorithm

The previous section provides an introduction to the algorithm to be discussed herein, with the descriptions and context for the input data and what the engine is to produce. This section discusses the core algorithm 404 (FIG. 4) to explain the concept behind the algorithm and an overview of the steps. An example of a pseudo-code implementation of this algorithm has been provided in an Appendix to this document.

In one embodiment, core algorithm 404 serves as the basic approach to distribution planning, and then built around this are additional features that can extended or provide minor modifications to the core algorithm to provide more capabilities. These additional discussed in the following sections.

### Processing Offset

In an embodiment, a feature of the core algorithm 404 is that it runs like a standard simulation based on time steps, but with a significant difference. A time-step based simulation will generally calculate what would happen with all the elements and interactions of elements in the simulation executing at a first point in time, and then advancing by one time increment to the next point in time and continuing in this manner, in order to predict future events within the simulated system. One example could involve a pool table on which we advance billiard balls on the table over a given period of time and then calculate the results of any objects interacting, such as balls colliding.

### Wait Time/Processing Time Offset

The Rapid Distribution Planning engine may also advance the time value in its algorithms/formulae by equal increments of time. However, we will not necessarily process the results for every element at the same point in time. Instead, we treat each of the locations per product as an object of the simulation. One location may be processed for a point in time that is three days into the future from a present moment, while another location may be processed for a point in time that is six days into the future from the present moment. This difference is called the Processing Time Offset and is used as a wait time for a location to begin processing.

The reason for the use of the processing time offset is that events occurring at a first location may not affect events at a second location for a finite, non-zero time period, due to the difference in lead times between the two locations. In one example, a product P1 shipping from a distribution center today, will arrive at a store Si three days from today. Thus, for the core engine to address both what is received in three days and what should be done in the distribution center today, it is desirable to simultaneously process events occurring at the both the store and at the distribution center, while taking the three-day offset into account.

We can create alignment of these locations where the action and reaction match by processing data representing events occurring at the respective locations, using values of time indicative of the point in time at which the respective events occur at the respective locations. Thus, in this example, data processing relating to events occurring at the store may employ a value of time that is three days ahead of the value of time used for processing of data relating to events occurring at the distribution center.

A time step in the algorithm may also be directly related to the time bucket described in the section herein entitled “Data Outputs.” This time step is preferably a value by which we increment the value of time to be used in processing data associated with the location at which events occur in the future, such as for instance, three days into the future as in the above example. The “time bucket” is preferably a value of time that the algorithm uses for processing data for a given location having a given time “argument”, and for which data is calculated and at least intermediately stored. Otherwise stated, in this embodiment, the “time step” is a “delta T” value, i.e. a difference in time between the time values associated with two respective locations within a distribution network. And, each time bucket is preferably a span of time define an absolute point in time at the start of the time bucket and another absolute point in time at the conclusion of the time bucket.

### Processing Offset Example

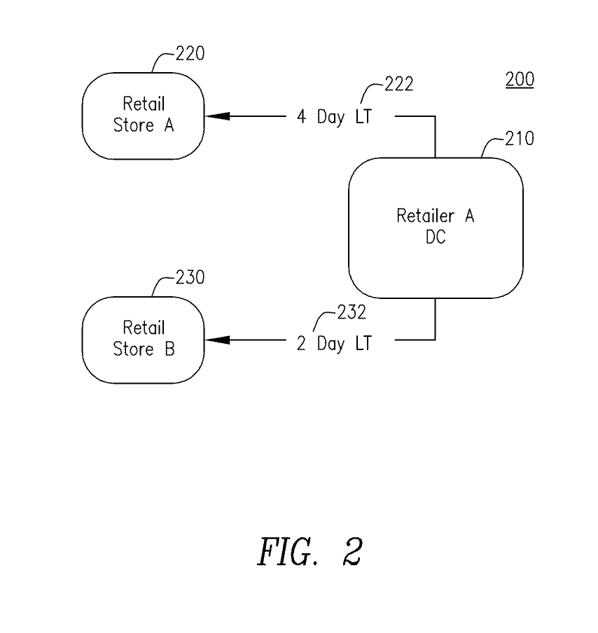

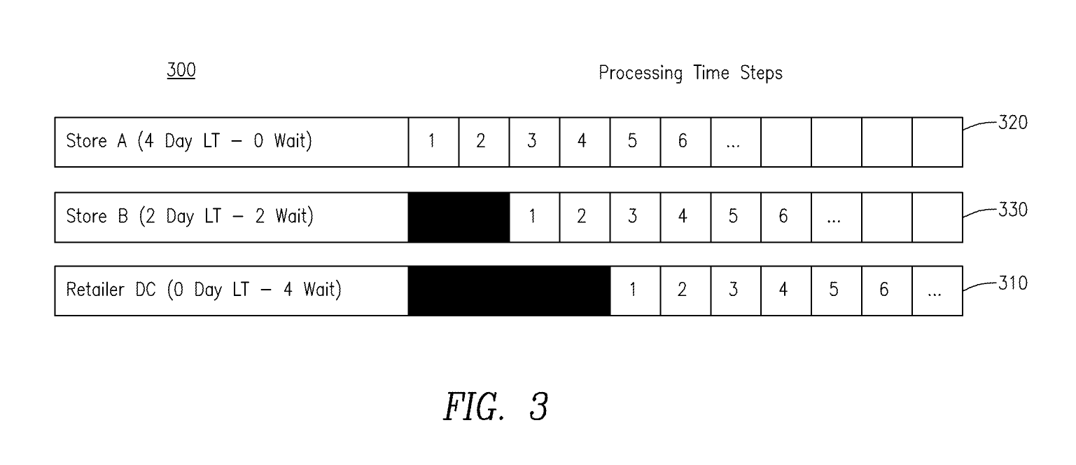

FIGS. 2-3 illustrate an example of a distribution network and how this offset functions. With the distribution network in FIG. 1, we show how multiple locations will align for this scenario. In FIG. 2, we graphically illustrate the processing offset.

In the processing offset diagram (FIG. 3), each location has a row (such as rows 310, 320, and 330 shown in FIG. 3) with a series of columns representing the time buckets. In FIG. 3, each time bucket, thus each block represents one day. Thus, in this example, a time bucket value of “1” refers to one day from today, thus tomorrow. A time bucket value of “2” refers to a day that is two days from the present day.

Going from left to right within FIG. 3 corresponds to an advancement through the respective time buckets. Thus, the first column is processed first, and then the algorithm advances to the next column. The black blocks represent time steps for which processing is not performed for the location associated with the applicable row. The delay period arising from a sequence of black blocks within one row of the chart of FIG. 3, is referred to herein as the “wait time” and may be calculated before the core algorithm runs. This subject is discussed further later in this document. The unit used to calculate wait time may preferably be the time bucket.

Thus, with reference to this example, when the algorithm reaches time step 5, the algorithm may determine what to ship from the retailer/distribution center (DC) to the retail stores (store A and/or store B) tomorrow. The shipment decision may affect one store 4 days from the date of the shipment decision, and the other store 2 days from the day of the shipment decision. In FIG. 3, the row for store A is labeled 320, and the row for store B is labeled 330. Retailer DC is labeled 310.

The core engine 402 preferably has data describing what the projected inventory will be at each store at the time of the arrival of product that tomorrow, because we have preferably already processed data describing what will happen at each store between the time of shipment and the time of arrival of the shipped product at one of the stores. In this way, the core engine 402 may better determine how much of each type of product will be needed, at each store, at the time of receipt of the goods by one or more of stores A 220 and B 230 (FIG. 2).

While the above example illustrates the concept with a single-tier distribution network, the concept is also applicable to a network with multiple tiers.

### High Level Algorithm Steps

The most basic steps of the algorithm may be repeated once for each product processed. The steps may include: (1) calculating Wait Times for each location; (2) calculating the time steps required to cover the planning period provided by the user; (3) starting with the first time step and for each time step, incrementing up, and performing the sub-steps of: (a) aggregating network demand for the various locations; and/or (b) processing time buckets for the various locations. The next few sections describe the major steps.

### Upstream and Downstream Recursion

One or more components of the core algorithm 404 may employ methods that run recursively to process data associated with the locations in the distribution network 100. There are two directions in which recursion may be performed: upstream and downstream, relative to the flow of products through the distribution network. (See the distribution network under the section Distribution Network with Lead Times).

Downstream recursion may begin at the root node of the distribution tree, which is the supply source 110, and may then process all of the children (i.e. downstream nodes in the distribution network) before continuing with the next set of children down to the leaf nodes. In other words, going from the source, for instance the manufacturing plant, down to the end consuming location, for instance retail stores. Thus, in the exemplary embodiment of FIG. 1, the leaf nodes may correspond to the retail stores 140.

Upstream recursion may operate in a manner opposite that of downstream recursion. In upstream recursion, we may process all of the child nodes first, and then move progressively upward within the hierarchy of nodes within a distribution network 100. Thus, for example, upstream recursion may start with stores 140 and may progress up to the manufacturing plant 110.

### Calculate Wait Time

Before the algorithm begins, it is beneficial to calculate the wait time for each location, as illustrated by the black blocks in FIG. 3. This is the time period, as measured in time steps, over which the algorithm will pause, before beginning to process the first time bucket for a location, thus creating the alignment discussed in the section herein entitled “Processing Offset.”

To calculate the wait time for a given location, the lead times may be summed to get the total lead time from the source to the given location. The lead time may then be recursively summed going downstream from the source and storing the value for each location.

Once this is done, the longest total lead time from the source is used to represent the location or locations that will be the first to start processing. The wait time for each location is calculated as the longest total lead time subtracted by the given location's total lead time from the source.

In the Process Offset Example of FIGS. 2-3, the wait times are “0” for Store A 220, 2 days for Store B 230, and 4 days for the Distribution Center A (DC) 210. The above offset calculation is preferably conducted for each distribution network.

### Aggregate Network Demand for Locations

During each time step, the core engine 402 may first calculate the demand requirements for each location to help determine the total quantity of each product that is demanded. The demand for a product, for a given location, may be arrived at by summing two sources of demand.

A first source of product demand for a given location may include independent demand which is demand directly from customers for product that ships from the given location to the customer. Two examples of independent demand are sales from retail stores and direct shipments to satisfy internet orders from distribution centers. Independent demand is represented by the Open Orders and Forecasted Demand described in the “Data Inputs” section of this document.

A second source of product demand for a given location may include dependent demand, which is demand from locations located directly downstream from the given location that require shipments to meet demand for the location or inventory target requirements. Dependent demand may include a distribution center having a value of product demand corresponding to a total of all of the demand from the stores it ships to or a manufacturing plant having a level of dependent demand corresponding to the total demand from all of the distribution centers it ships to.

Because dependent demand is based on downstream demand, the summation of the quantity of product demanded for an entire distribution network preferably uses upstream recursion. Thus, the recursive calculation preferably starts at the store level, and the summation proceeds upward in the distribution network toward the supply source (see FIG. 1). The summation is only conducted for locations that are being processed and not for those that are still waiting to be processed.

Multiple types of demand can be defined and prioritized as part of the flexibility of the core engine. An example of this is meeting forecast customer demand before fulfilling replenishment of inventory to target levels.

### Process Time Bucket for Locations

Once the product demand requirements have been calculated, the engine can calculate predicted values and make decisions where conflicts exist. Processing of the demand calculation is preferably conducted for the current time bucket for each location being processed.

### Downstream Recursion

Since products are shipped in the downstream direction, the core engine 402 preferably also processes data for each location recursively in the downstream direction, starting at the supply source 110.

Before a time bucket is processed for a given location, the core engine 402 checks the wait time for the given location to see if it has expired, which would correspond to the wait time having reached a zero value. If the wait time has not reached zero value, then the wait time is decremented by one time step and the core engine continues on to the next location.

The expressions in parentheses in FIG. 3 work as follows:

Each location has a representation of buckets of time (one day for example) where each location includes data identifying how much inventory is on hand on that day, the quantity of product to be directed to downstream locations, and how much product is received or shipped out. All of these values may be calculated for each location (i.e. store A, store B, and/or Retailer DC) and for each time bucket (i.e. time period). When one location is providing a quantity of product to another location, there is an offset in lead time (i.e. the amount of time it takes for the product to be shipped from an originating location and to be received at the destination location). To determine the quantity of product to be shipped to a given downstream consumption location from a supply location, we consider the amount of product (amount of product to be consumed) in the future, since it will take us a period of time corresponding to the lead time (for the shipper with respect to the destination) to deliver the applicable quantity of product.

We use the lead times to align the buckets (time periods) between upstream and downstream locations based on the time offsets between the shipment location and receipt location, to enable calculation of the quantity of product needed, while taking the time offsets between the different locations into account. We adjust the time value associated with each location using the various offsets to help determine the locations of various product shipments at various points in time. The lead time at the “most downstream” location is set to a zero reference value, and the lead time for all other locations is measured with respect to that zero reference.

Accordingly, the items in parentheses represent:

(Lead Time from Retail DC (Distribution Center)—This is the amount of time the algorithm waits to start processing buckets for the given location).

Store A 320:

Has a four day lead time from the Retailer DC 310.

Because this location has the longest offset, the wait time is 0, and the algorithm starts processing the buckets here first.

Store B 330:

Has a two day lead time from the Retailer DC 310.

Because it has a shorter lead time, and the difference with the longest lead time is two days, we will wait two buckets (two units of time) until processing data for this location.

Retailer DC 310:

Has a zero-day lead time, because this lead time is relative to Retailer Dc 310 itself. Because, relative to the longest lead time (Store A), Retailer DC has a 4 day wait, Retailer DC 310 may wait for four days before starting processing.

The above describes a two-level distribution network, but the principles apply across a more complex distribution network. The application equation is: TIME OFFSET (or wait time for a given location)=LONGEST TOTAL LEAD TIME—TOTAL LEAD TIME (for the given location supplied).

When shipment quantities are calculated for a particular time bucket, for a given location, the steps undertaken for the calculations may vary in composition and order based on needs of the planners. In one embodiment, the steps that are executed to calculate the shipment quantities may include the following:

1. Determining the total demand requirements (independent and dependent demand);
2. Establishing the quantity of supply of product that is available (on-hand inventory, incoming transfer orders, and expected supply plan);
3. Allocating the supply against the demand while updating corresponding transfer orders and/or supply plan quantities (see the next section, Supply Allocation, for details);
4. Calculating the quantities for the given location for the particular time bucket as discussed in the Data Output section; and/or
5. Incrementing the current time bucket to the next bucket for the given location (for the next time step).

In the above, we are calculating the amount of supply from a location to another location. Please see the next section in relation to the equation examples that could be used for step 3 above, keeping in mind that if the supply is available, then the supply matches demand. For step 4, the data outputs are fairly straightforward; the data outputs are the result of the amount of supply allocated and its effects. The amount of product supplied may include the quantity of product to be shipped from the available supply inventory, and the extent to which the shipment changes the amount of product in inventory.

Supply Allocation

Processing data for locations for specific time buckets may include calculating supply allocation which matches up quantities demanded of a product with the available supplies of the product. The allocation of available supplies is a simple matter when the quantity of the product supply exceeds the quantity of the product that is being demanded, from all sources of demand. In this simple case, the quantity demanded can be easily met by the available supply of product.

When the quantity of product that is available (i.e. the supply) is less than the quantity demanded of the product, then the available supply of the product is preferably allocated among the demanding entities according to a specified formula or algorithm.

If supply is greater than demand, then all supplies are satisfied. If not, then we need to determine how much of the limited supply goes to which consumer. Below are some examples of how we may allocate a limited supply of product among various competing destinations for the product.

### A) Simple Percentage Based Approach:

For Each Consumer:

| | |
|---|---|
| 1. | Consumer Percentage = Consumer Demand/Total of All Consumers |
| | Demand |
| 2. | Ship Quantity = Supply Quantity * Consumer Percentage |

### B) Simple Consumer Priority Wins:

Sort consumers by a priority designator. For each consumer in order of priority:

| | |
|---|---|
| 1. | If Consumer Demand Quantity < Supply Quantity |
| • | Ship Quantity = Consumer Demand Quantity |
| 2. | Else |
| • | Ship Quantity = Supply Quantity |
| 3. | Supply Quantity = Supply Quantity − Ship Quantity |

Other examples can be envisaged, such as weighting based on profitability.

In an embodiment, a method may be used to divide the available supply of a given product type among the various types of demand and/or among a plurality of demanding entities that may be located at various different levels of hierarchy in the distribution network 100 (FIG. 1). A method according to this embodiment may be implemented in a multitude of ways and the method to be employed may be selected based on what best addresses the business needs of the various demanding entities and/or of the distribution network 100 as a whole. An embodiment of the core engine 402 preferably allows a plurality of different algorithms to be employed for allocating a limited supply of product among a plurality of demanding entities, and preferably enables the ability to develop additional, modified algorithms to meet changing needs of the various entities within distribution network 100.

In an embodiment, a first allocation process may allocate quantities of product among demanding entities according to the type of demand. A method according to a preferred embodiment may allocate product to customer-driven demand first and inventory target demand driven second, and then allocate further quantities of product according to a prioritization of supplied locations. Prioritizing the supplied locations may include assigning a range of priority ratings to various stores for deciding the order in which product is allocated to the respective supplied locations, such as retail stores.

To illustrate the operation of an exemplary allocation scheme, we make reference to the example of FIGS. 2-3. For the sake of this example, retail store demand is accorded the highest level of priority, and a lower level of priority is provided to replenishing inventory targets. Beyond the priority by “type” of demand above, we further establish priorities among the retails stores by according a higher priority to store A 220 than to store B 230.

Below, we present a list of destinations for product, listed in order of descending priority level, starting with the highest priority level.

### 1. Store A—Customer Demand

### 2. Store B—Customer Demand

### 3. Store A—Inventory Target Replenishment

### 4. Store B—Inventory Target Replenishment

The above-illustrated allocation method would take a quantity of the available supply of product to satisfy the demand of each of items (1) through (4) above as well as possible, while proceeding through the list from item (1) to item (4). Once the supply is exhausted, the allocation algorithm preferably concludes, and any unsatisfied demand among items (1) through (4) would be tracked by the core engine.

In one embodiment, an allocation algorithm could simply divide the available product among the demanding entities (i.e. the sources of demand) according to an apportionment formula. For example, the available supply of formula could be allocated in proportion to the total sales volume of each store, in proportion to the total storage capacity for the product in question of each store, in proportion to the rate of sales of the product at each store, and/or other characteristic of the demanding entities.

At the furthest upstream location which serves as source for products, such as supply source 110 (FIG. 1), there may be supply levels that remain constant over a period of time that extends over several time buckets. In other cases, the available supply of each type of product may fluctuate (because of shipments or other factors) in which case additional product may be provided to supply source 110 to replenish the supply level.

One possible variable supply plan is an “unlimited supply plan” which just means that the supply plan becomes the total of demand. When the supply quantity for the entire distribution network is unlimited, the supply quantity is therefore simply the sum of all downstream demand quantities. This is because if supplying a distribution network is the only constraint to the quantity of product, then the supply quantity merely needs to be equal to the total quantity demanded of the all consumers in the network.

One approach to constraining the supply plan is covered in the advanced features, Integration of Material/Capacity Planning section herein. The supply plan algorithms may be expanded upon with additional type of allocation heuristics and rules, including utilization of basic optimization techniques.

### Distribution Planning Advanced Features

What has been described so far is an embodiment of the core data and algorithm at the heart of the Rapid Distribution Planning system. This core is configured so as to be amenable to being enhanced with more advanced techniques and functionality to further expand the basic capabilities of this planning module. This section describes these more advanced features that make additions or alterations to the core.

Some of the advanced features described in the following may employ optimization theory mathematical techniques to provide calculated results (such as Integer Programming or Constraint Programming). The use of optimization theory mathematical techniques may be used without the system being an APS-based system. This approach preferably reduces the complexity of the system and preferably focuses on basic optimization problems that are easier for planners to understand and still have faster execution times.

Conflict and Decision Tracking with Planner Drill Down

In an embodiment, as the distribution planning algorithm executes, it identifies conflicts, especially when the quantity demanded exceeds the available supply quantity, and makes decisions, typically based on supply allocation among various demanding entities. By presenting these conflicts and allowing planners to examine the decisions made by the core engine and the data used to make the decisions, the system enables planners to more actively participate in the planning.

Using the above approach, planners may gain an understanding as to why the engine has made certain decisions, where issues exist in the distribution network, and may override the decisions where such intervention is warranted. The overrides can then be tracked by the core engine so that a subsequent run of the distribution planning algorithm will make the decisions chosen by the planner.

### Cross Transfers to Balance Inventory

In some cases, a distribution network may become unbalanced as a result of factors including: (a) inaccuracies in demand forecasting; and/or (b) imbalances in the quantities of product inventory among the various locations. Simply stated, there could be too much inventory in one location, and too little in another.

Using basic optimization-theory-based modeling and calculations, new transfer orders, that do not follow the distribution network connections, can be created to balance out this inventory.

An example of the above may involve sending products between distribution centers on the same tier of the distribution network achieve a more equal distribution of inventory of a given product.

### Integrated Inventory Optimization

The core engine may use data indicative of the target inventory as input. The core engine may also incorporate statistical or optimization techniques to improve the target inventory level to used in any calculations. This approach may allow inventory optimization to be processed as part of the distribution planning that would take into account the data available to and calculated by the distribution engine in determining targets that could vary over time to best meet the circumstances predicted by the engine.

### Multiple Supply Location Options

In one embodiment, the core engine may model the distribution network as being strictly hierarchical in nature. Therefore, in this embodiment, any location that is supplied by another can only have one supplying location or “parent.” This simplified model does not allow for multiple supply points, which can be useful when a product can be manufactured at multiple plants, or when multiple distribution centers are capable of shipping the product to the same store.

Methods for implementing the above may include the following:

(1) We may make temporary changes to the data model of the distribution network 100 during execution of one or more algorithms in the core engine to allow for changes in the source of product for given point on the distribution network 100 when the upstream node, or “parent”, changes for a finite period of time in actual operation of the distribution network 100.
(2) We may identify scenarios where an alternative supply location is desirable after a first pass of the distribution planning algorithm. We may then add the desired transfer orders and lock them in and run the algorithm again after the orders have been added.

Optimization techniques could also be applied to these implementations to determine the best sourcing alternative when supply issues are identified.

### Automation of Multiple Scenario Runs

In an embodiment, the rapid operation of the core engine preferably enables the core engine to perform multiple passes over the various locations and/or time buckets, even when a large number of products and locations are included as part of distribution network 100. This feature preferably enables the core engine to vary the parameters used and to vary the decisions made so as to generate multiple scenarios. The output data from the runs of the respective scenarios may then be compared to one another to determine which of the scenarios yields the most desirable results.

The planning parameters and decisions can be further optimized with optimization techniques in conjunction with this multi-pass methodology.

### Integration of Material/Capacity Planning

So far the supply plan has been discussed in terms of having a first component of the supply quantity being fixed, and a second component of the supply quantity being variable without any constraint. Since materials and capacity are almost never completely unconstrained under real-world conditions, integrating material and capacity planning functionality with the distribution planning engine may be desirable.

Many different techniques for material and capacity planning have been designed and implemented which can be applied to the distribution planning engine (i.e. MRP-II). The simplest form of the above-referenced integration would be to have the distribution planning algorithm run in an unconstrained manner once, and to then adjust the supply plan by imposing constraints. Thereafter, we may lock the supply plan and have the algorithm run again.

More complex integrations could involve having a material and capacity constraint technique applied whenever the distribution planning engine adjusts the supply plan and makes decisions on the fly about supply. This approach may provide the added benefit of allowing for further optimization of a final supply plan.

### Integration of Transportation Optimization

Transportation optimization preferably operates to minimize transportation costs and to maximize efficiency of on-time delivery by analyzing multiple potential modes of transportation and multiple routes. As with the integration of material and capacity planning, these types of solutions could also extend the distribution planning to provide further benefits in transportation logistics to this planning system.

Integration with Collaborative Planning, Forecasting & Replenishment

Collaborative Planning, Forecasting, and Replenishment (CPFR) are a defined set of processes for working with trading partners to determine a plan for fulfilling demand based on future predictions by multiple parties (see CPRF references on the internet). Rapid Distribution Planning may serve as a complement to the processes as they typically occur over short planning time periods (for instance a week) and tend to benefit from rapid decision making. When coupled with CPFR, the results of decisions made and of the potential plans can be analyzed for feasibility and overall distribution impact, thereby providing a better end result for the final plans.

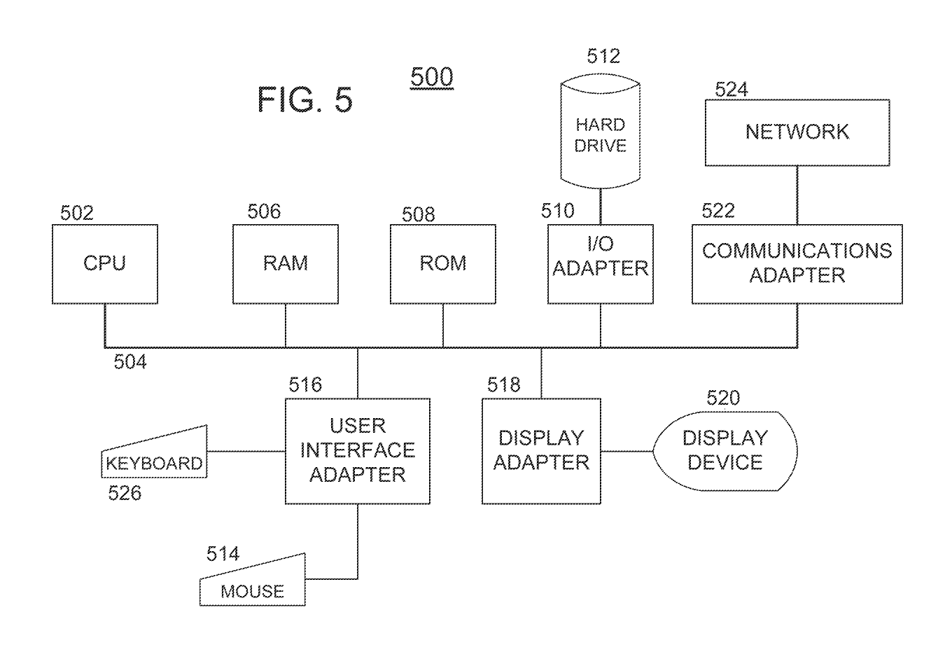

FIG. 5 is a block diagram of a computing system 500 adaptable for use with one or more embodiments of the present invention. Central processing unit (CPU) 502 may be coupled to bus 504. In addition, bus 504 may be coupled to random access memory (RAM) 506, read only memory (ROM) 508, input/output (I/O) adapter 510, communications adapter 522, user interface adapter 506, and display adapter 518.

In an embodiment, RAM 506 and/or ROM 508 may hold user data, system data, and/or programs. I/O adapter 510 may connect storage devices, such as hard drive 512, a CD-ROM (not shown), or other mass storage device to computing system 500. Communications adapter 522 may couple computing system 500 to a local, wide-area, or global network 524. User interface adapter 516 may couple user input devices, such as keyboard 526, scanner 528 and/or pointing device 514, to computing system 500. Moreover, display adapter 518 may be driven by CPU 502 to control the display on display device 520. CPU 502 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method comprising:
(a) Constructing a time series of data structures for each of a plurality of nodes in a distribution system,
(b) Running corresponding data structures for each node iteratively, in sequence, through a simulation algorithm to obtain a result,
(c) Using said result to run corresponding data structures for each node through a subsequent iteration of said simulation algorithm,
(d) Repeating steps (b) and (c) until all data structures from each node have been run through said simulation algorithm, wherein correspondence of data structures between nodes are those offset by a time delay, for each node, between a specified node and said each node, such that said data structures for said each node are not run through said simulation algorithm until an nth iteration of said simulation algorithm, wherein n is the offset between said each node and said specified node.

2. A method for replenishing product in an inventory of a distribution network having a plurality of levels, the method comprising the steps of:
(a) determining an independent quantity demanded of a product at a first-level entity of the distribution network associated with customer demand directly from the first-level entity;
(b) determining a dependent quantity demanded of the product at the first-level entity associated with overall demand from the distribution network apportioned to the first-level entity;
(c) summing the quantities demanded in steps (a) and (b) to determine a total quantity demanded for the first-level entity;
(d) repeating steps (a) through (c) for levels of the distribution network eligible for processing up to a highest-level entity of the distribution network, thereby generating a plurality of quantity-demanded sums for the respective entities; and
(e) calculating a total quantity demanded for the product for the distribution network by summing the quantity-demanded sums of the respective entities.

3. The method of claim 2 further comprising:
(f) according a plurality of different respective wait-time values to the plurality of levels of the distribution network.

4. The method of claim 3 further comprising:
(g) decrementing the wait time values by a value of one each time step (d) is executed.

5. The method of claim 4 further comprising:
(h) identifying a level of the distribution network as eligible for processing when its wait time value is equal to zero.

6. The method of claim 3 further comprising:
repeating steps (a) through (h) until quantity-demanded sums have been generated for all levels of the distribution network.

7. The method of claim 2 wherein each unit of wait time is a day.

8. The method of claim 2 further comprising replenishing the inventory of the product in accordance with the calculated total quantity demanded of the product for the distribution network.

9. A method comprising:
(a) determining a total of demand requirements of a product for a first location within a distribution network for a first time segment;
(b) determining a quantity of supply of the product available at the location; and
(c) selecting an allocation of the available supply of product among competing sources of demand including (i) customer demand from the location; and (ii) replenishment of inventory of the product;
(d) exempting from calculation any time-dependent functions indicative of demand or supply quantities that are not ripe for calculation;
(e) shipping product in accordance with parameters output by said method.

10. The method of claim 9 further comprising:
(e) repeating steps (a) through (d) for a sequence of locations within a distribution network.

11. The method of claim 10 further comprising:
proceeding the sequence of locations from a highest level to a lowest, retail store level.

12. The method of claim 10 further comprising:
proceeding through the sequence of locations from a lowest-level, retain store level to a highest level of the distribution network.

13. The method of claim 10 further comprising:
(f) updating a time value referenced within time-dependent functions indicative of demand or supply quantities at the respective locations

14. The method of claim 13 further comprising:
(i) repeating steps (a) through (e) using the updated time value.

15. The method of claim 9 wherein the step of selecting an allocation further comprises the step of:
establishing a priority hierarchy among a plurality of customers associated with the location.

16. The method of claim 9 further comprising:
shipping product through the distribution network in accordance with the allocation selected in step (c).
